(19) United States
(12) Patent Application Publication
(10) Pub. No.: US 2009/0268569 A1
(43) Pub. Date: Oct. 29, 2009

(54) METHOD OF MECHANICAL SHOCK DETECTION AND METHOD AND APPARATUS FOR RECORDING DATA ONTO AN OPTICAL DISC

(75) Inventors: Stefan Hendrik Guillaume Steven, Eindhoven (NL); Omar Shareef Malik, Stirling (GB); Hendrikus Albertus Johanna Looijmans, Eindhoven (NL); Bert Knoors, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,672

(22) PCT Filed: Apr. 14, 2006
(86) PCT No.: PCT/IB06/51173

§ 371 Date: Oct. 16, 2007

(30) Foreign Application Priority Data
Apr. 22, 2005 (EP) 05103287.8

(51) Int. Cl. G11B 20/10; G11B 7/00

(52) U.S. Cl. 369/47.14; 369/112.23; G9B/7; G9B/20.009

(57) ABSTRACT

A method for detecting a mechanical shock affecting on optical disc drive based on using the Focus Error (FE) and/or the Tracking Error (TE) servo-loop signals. An shock detection signal is generated as weighted time-integral of the servo loop signal, for example by using the integral signal of the PID controller of the servo loop, or a low pass filter, or digital integration by a Digital Signal Processor (DSP). A shock is considered to be detected if the shock detection signal exceeds a threshold value. A method for recording data onto an optical disc and the corresponding optical disc drive are also disclosed. The shock signal is monitored real time and the recording is interrupted if a shock is detected. The recording is resumed by linking from the last recorded area when the shock signal becomes low again.

### FIELD OF THE INVENTION

The present invention relates generally to a method for detecting a mechanical shock affecting an optical disc drive during reading or recording an optical disc. The present invention also relates to an apparatus and a method for recording data onto an optical disc.

### BACKGROUND OF THE INVENTION

The use of optical disc recording in portable systems, for example recording various types of compact discs (CD) and Digital Versatile Discs (DVD) in laptops, has recently become widespread. Their use in miscellaneous environments, including many sources of vibrations and mechanical shocks, may lead to errors during the recording due to focusing errors or loss of track. Consequently, it is desirable that recording devices use some method to mitigate the effect of vibrations and mechanical shocks so that the quality of the recording is not affected.

One option is to make use of an external shock sensor to detect external shocks affecting the recording device. This solution is less attractive due to higher production costs and a more complex assembly procedure. The published US patent application no. 2004/0069962A1 discloses the use of several servo loop feedback signals, already generated in present optical disc drive, to detect the presence of external shocks. It discloses the concomitant use of three independent shock detection units, a shock being detected if each of the three detection units simultaneously generates a shock signal. The first detection unit comprises either a tracking error (TE) sensor or a focusing error sensor (FE) or a central error (CS) sensor, a band pass filter centered on the resonance frequency of the suspension rubbers and two comparators. The second detection unit comprises either a sub-beam sum (SBAD) sensor or a RF ripple sensor (RFRS) a low-pass filter, a substractor and a hysteresis comparator. The third detection unit comprises means generating a rotating frequency-identifying signal of the spindle motor (FG), an averaging unit and a hysteresis comparator.

An essential parameter of a shock detection system is the characteristic response time. Preferably, a shock should be detected fast enough so that the recording process is interrupted before any recording errors are made. US 2004/0069962A1 discloses the use of three independent shock detection units which all have to concur in detecting a shock, therefore the characteristic response time of the proposed method is given by the slowest of the response times of each detection units.

### SUMMARY OF THE INVENTION

It is an object of the invention to provide an improved method for detecting a mechanical shock affecting an optical disc drive during reading or recording information onto an optical disc. This object is achieved by a method according to the invention characterized as recited in the characterizing part of claim 1. The method provides a combination of a very fast characteristic response time and of a good detection accuracy. Moreover, it has the additional advantage of being relatively simple and easy to implement. From available control (servo) signals such as TE, FE, CS, SBAD, RFRS or FG, the fastest response time is provided by the focus error (FE) signal for shocks perpendicular to the disc plane and by the tracking error (TE) for shock in the plane of the disc. Consequently, choosing the focus error (FE) and/or the tracking error (TE) allows a fast response time. In order to further improve the response time, one may set the threshold value very low. However, due to the inherent noise of such control (servo) signal, it leads to false alarms due to erroneous detection of mechanical shocks. The use of time integration reduces noise and consequently eliminates detection errors due to signal noise while maintaining a very fast response time.

In an advantageous embodiment, the method further comprises subtracting from the used servo signal a memory loop signal, the memory loop signal being generated by passing the used servo signal through a memory loop filter. In optical disc drive, the noise is coupled to the angle/rotation frequency of the disc and the noise changes slowly from track to track. This noise is referred in the art as disc noise. Apart from disc noise there are also repetitive disturbances caused by disc eccentricity and skew. The method according to the invention also addresses these disturbances. When the noisy servo signals FE and/or TE are stored into a memory loop, they can be subtracted from the actual FE and/or TE servo signals. The outcome is a virtually noise free servo error signal. In technical terms, the noise components at the fundamental disc frequency and harmonics are considerably reduced.

Advantageously, in a method according to the invention, the subtraction is performed after the weighted time integration. This corresponds to a more efficient and cheaper implementation with respect to memory usage, since the number of samples per revolution can be reduced when using time-weighted integrated signals.

Advantageously, a comb filter can be used for the memory loop filter. The use of a comb filter instead of a simple memory loop filter without any feedback path is more robust in the sense that it ensures that only repetitive noise components are tackled.

In an advantageous embodiment, the focus error (FE) signal is used as the servo signal. Optical discs making use of phase change technology, e.g. media of the rewritable type, are sensitive to variations in the laser power per unit area. This leads to higher sensitivity to focusing errors, which affect the effective laser power per unit area. Therefore, the focus error (FE) signal may be used to advantage, providing the fastest response time to the type of mechanical shocks that the recording process is most sensitive to.

An advantageous embodiment is obtained in an embodiment according to claim 6. The simultaneous use of both the focus error (FE) signal and tracking error (TE) signal has the advantage of high sensitivity to shocks in all directions.

US 2004/0069962A1 discloses combining either focus error (FE), or tracking error (TE) or central error (CE) with a band pass filter centered on the mechanical resonance frequency of the optical disc drive as one detection unit of the three detection units used simultaneously. A band pass filter is less advantageous not only due to the fact that it is more difficult and expensive to implement, but also due to the fact that the bandwidth has to be maintained rather large to compensate for changes in the mechanical resonance frequency due to, for example, changes in the temperature of the drive. A large bandwidth implies a higher sensitivity to signal noise, resulting in a reduced signal to noise ratio and a lower characteristic response time.

An alternative embodiment may be obtained by also filtering FE/TE error signal by a low pass filter whose cut off frequency is below a mechanical resonance frequency of the optical disc drive. This allows achieving a good signal to noise ratio for the shock detection signal. Preferably, the cut off frequency is chosen below 15 Hz.

An improved embodiment is obtained by the measures of setting the threshold value to 2% of the maximum focus error (FE) signal. Setting a low value of the threshold leads to false shock detection alarms due to signal noise. Setting a higher value of the threshold reduces the response time and increases the risk that errors may be made during the recording process. A value of the threshold of 2% of the maximum focus error (FE) signal provides an optimum between the signal to noise ratio and the response time.

An advantageous embodiment is obtained by the measures of claim 9. Generating a scratch detection signal based on the FE/TE error signal has the advantage that it allows to be distinguished between damages of the disc due to scratches or dirt on the surface and mechanical shocks. Scratched or dirt on the surface of the disc affect the reflected laser beam and correspondingly the FE/TE error signals and may lead to false shock detection alarms. Mechanical shocks lead to lower characteristic disturbance frequencies in the servo loop signals than disc defects, therefore by a proper signal analysis one can separate between the two. The simplest embodiment corresponds to measuring the characteristic rise time of the shock detection signal. If the rise time is faster than a threshold value, the shock detection signal is due to disc defects and not to mechanical shocks. A preferred embodiment is obtained when the rise time is measured by the measures of claim 9. Measuring the rise time between two threshold levels can be software implemented in the digital signal processor, therefore no costly hardware modifications are required.

The invention also relates to an apparatus for recording an optical disc according to the characterizing part of claim 11.

In an embodiment, the time integration, that may be obtained by using the integral part of the PID controller of a corresponding FE/TE servo loop. It has the advantage that it provides a time integration of the FE/TE error signal without requiring external components to be added to the optical disc drive.

An improved embodiment may be obtained according to the measures of claim 11. The time integration being performed by a digital signal processor has the advantage that it may be implemented by means of firmware and no costly hardware modifications need to be made to optical disk drive. A further improvement can be obtained if the comparison of the shock detection signal to the threshold value and the corresponding decision that a mechanical shock is present are performed by the same digital signal processor. This bears the same advantage that it may be implemented by means of firmware and no costly hardware modifications need to be made to the optical disc drive.

The invention also relates to a method of recording an optical disc according to claim 24. Interrupting the process of recording data onto the optical disc if a mechanical shock is detected according to the measures of the invention and subsequently resuming the recording via a suitable linking method has the advantage that recording errors due to mechanical shocks are avoided.

These and other aspects of the invention are apparent from and will be explained with reference to the embodiments described hereinafter.

### BRIEF DESCRIPTION OF THE DRAWINGS

The features and advantages of the invention will be appreciated upon reference to the following drawings, in which:

FIG. 1 shows schematically a block diagram of a typical optical disc drive;

FIG. 2a and FIG. 2b show schematically the block diagram of a servo loop (30) and of a shock detection system (20), according to a first and a second embodiment of the invention;

FIG. 3 shows schematically the block diagram of the shock detection system (20) according to a third embodiment of the invention.

FIG. 4 shows schematically the block diagram of the shock detection system (20) according to fourth embodiment of the invention.

FIGS. 5a and 5b show schematically the block diagram of the shock detection system (20) according to fifth and sixth embodiment of the invention.

FIG. 6 shows schematically the block diagram of a memory loop filter.

FIG. 7 illustrates by means of a flow diagram a method for recording an optical disc according to an embodiment of the invention.

FIG. 8 illustrates by means of a flow diagram a method for generating the shock detection signal according to an embodiment of the invention.

FIG. 9 shows illustrates how based the time evolution of a integrated error signal a mechanical shock is detected according to a preferred embodiment of the invention

### DETAILED DESCRIPTION OF THE PREFERRED EMBODIMENTS

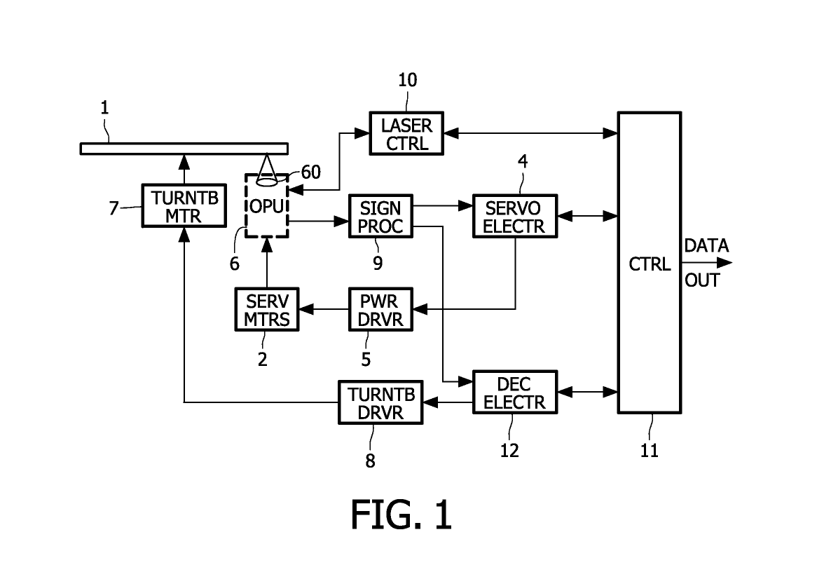

A block diagram of a typical optical disc drive is shown in FIG. 1. Encoded information stored on the optical disc (1) is read or encoded information is recorded onto the disc by means of an Optical Pick-up Unit (OPU) (6). The Optical Pick-up Unit (6) generates and focuses a laser beam onto the optical disc and it also receives a reflected laser beam which is optically modulated by a periodical structure on the optical disc (1). The Optical Pick-up Unit (6) comprises, among others components, a semiconductor laser for generating the laser beam, a lens system (60) for focusing the beam on the disc, and a detection system comprising several photodiodes for transforming the received reflected laser beam into photocurrents. The output power of the laser is controlled by a laser controller (10), which on its turn is controlled by a digital signal processor (11). By properly processing the photocurrents according to methods known to the person skilled in the art, several control signals, comprising among other signals known in the art under the name servo signals, and a high frequency (HF) signal comprising the encoded information recorded on the optical disc (1) are derived. Examples of such control signals known in the art are a tracking error signal (TE), a focusing error signal (FE), a central error (CE) signal (also referred as a main push pull signal MPP), a sum bead signal (SBAD), and an RF ripple signal (RFRS).

The functionality of all electromechanical components is controlled by a firmware program running in a microcontroller, usually also comprising a digital signal processor (DSP) (110).

The optical disc (1) is rotated by a turntable motor (7). The rotation velocity of the turntable motor (7) is controlled by a turntable motor driver (8), which receives control signals from a decoder unit (12).

The control signals and the high frequency (HF) signal generated by the Optical Pick-up Unit (OPU) (6) are fed to a preprocessing unit (9) which pre-amplifies and, optionally filters the said signals. The pre-processed high frequency (HF) signal is fed to the decoder unit (12), which decodes the incoming high frequency (HF) signal to obtain the information stored on the disc. The decoder unit (12) may also perform error detection and correction. The decoded information is fed to the microcontroller (110), which may further process the decoded information.

Fine displacement of the lens system (60) along the axial and the radial direction and coarse displacement of the whole Optical Pick-up Unit (OPU) (6) with respect to the optical disc (1) is accomplished by a servo motor system (2), the servo motor system also known in the art as a two stage or a sledge-actuator servo system. The servo motor system (2) is controlled by corresponding servo power drivers (5). The servo power drivers (5) receive control signals from a servo unit (4). The servo unit (4) receives the pre-processed servo signals from the pre-processing unit (3) and is controlled by the microcontroller (11).

For each control signal, for example the tracking error signal (TE), the focusing error signal (FE), the central error (CE) signal, the sum bead signal SBAD and the RF ripple signal RFRS a separate control loop is present. If the control signal is a servo signal (FE/TE), the control loop is also known as a servo loop. The system formed by the Optical Pick-up Unit (6), pre-processing unit (3), the servo unit (4), the servo power drivers (5) and the servo motor system (2) is known in the art under the name servo loop (30) and is responsible for controlling the positioning of the OPU (6) or of the lens system (60) a with respect to the optical disc (1). In FIG. 1, details of each servo loop are not shown for simplicity.

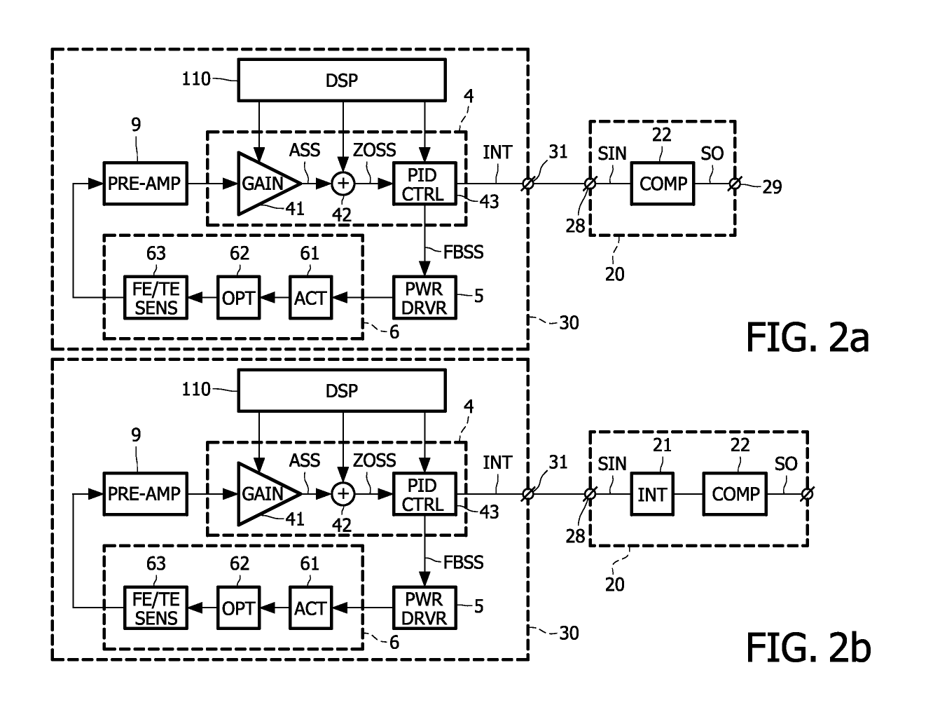

Further details of a servo loop (30) corresponding to a specific servo signal will be discussed with reference to FIG. 2. Throughout the figures, when the same functional element appears in several figures, the same reference numeral is used to simplify understanding.

FIG. 2a shows schematically the block diagram of a servo loop (30) and of a shock detection system (20), each according to a first embodiment of the invention.

The servo loop (30) comprises: an optical imaging system (62), an servo sensor (63), a position actuator (61), a pre-amplifier (9), a variable gain amplifier (41), an offset comparator (42), a PID controller (43), servo power drivers (5) and the digital signal processor (110), the digital signal processor being in general part of the microcontroller (11). The optical imaging system (62), the servo sensor (63) and the position actuator (61) are comprised within the OPU (6). The variable gain amplifier (41), the offset comparator (42), and the PID controller (43) are comprised within the servo unit (4).

The optical imaging system (62), which comprises the lens system (60), generates a laser beam, focuses the laser beam on the disc and focuses the laser beam reflected by the disc onto the detection system comprising several photodiodes. The servo sensor generates a servo signal (SS) by processing the photocurrents generated by the detection system. The servo signal (SS) is then pre-amplified by the pre-amplifier (9). The pre-amplified servo signal (PASS) is then amplified by the variable gain amplifier (41). The gain of the variable gain amplifier (41) is controlled by the Digital Signal Processor (DSP) (11). The role of the variable gain amplifier (42) is to control the total gain of the servo loop. Any offset present in the amplified servo signal (ASS) is removed by the offset comparator (43). The offset comparator is also controlled by the Digital Signal Processor (DSP) (110). In an alternative embodiment, the offset comparator (43) and the pre amplifier (9) may be integrated into the same amplification unit. The zero offset loop signal (ZOSS) is then sent to the Proportional Integral Derivative (PID) controller (43). The role of the PID controller is to provide feedback so that the value of the servo signal (SS) is maintained within a certain range. In an alternative embodiment, the functions of the PID controller may be partially integrated in the Digital Signal Processor (DSP) (110). The values of the proportional, integral and derivative components of the feedback signal (FBSS) generated by the PID controller (PID) are controlled by Digital Signal Processor (DSP) (110). The feedback signal (FBSS) generated by the PID controller is fed to the servo power drivers (5), which cause the movement of the corresponding actuator (61). Changes in the actuator position produce corresponding changes in the intensity of the laser beam detected by the detection system and consequently the servo signal (SS) generated by the servo sensor (63), therefore closing the servo loop.

When mechanical shocks affect the optical disc drive, the position of the lens system (60) relative to the optical disc (1) is affected. The value of a servo signal (SS) generated by the servo sensor (63) is also modified, and consequently may be used for detecting mechanical shocks. From available servo signals such as TE, FE, CS, SBAD, RFRS or FG, the fastest response time is provided by the focus error (FE) signal for shocks in the axial direction (perpendicular to the disc plane) and by the tracking error (TE) for shock in the plane of the disc. Therefore either the focus error (FE) servo signal or the tracking error (TE) servo signal should preferably be used in detecting mechanical shocks. If the optical disc (1) makes use of the phase change recording technology, technology usually used in rewritable discs (for example, CD-RW, DVD+RW, DVD-RW), this implies that a very narrow window of laser powers are available for recording. If the effective distance between the lens system (60) and optical disc (1) varies due to a mechanical shock, this lead to focus errors and variations in the effective spot size. The variations in spot size due to focus error are equivalent to changes in the effective laser power per unit area. Consequently, an optical disc (1) making use of the phase change recording technology is most sensitive during recording to mechanical shocks in the axial direction, affecting the effective distance between the lens system (60) and optical disc (1). For these discs, the focus error (FE) signal is chosen preferably as the servo signal used for shock detection.

FE/TE error signals have an inherent noise that may lead to false alarms due to erroneous detection of mechanical shocks. A known method for reducing noise is to make use of an integrator filter.

In time domain, if s(t) is the signal to be integrated over a period Δt, it corresponds to an output signal sₒᵤₜ(t)

$${s}_{out} ( t ) = {\int }_{t - Δ t}^{t} s ( t ) d t$$

Correspondingly, in a frequency domain, if the input signal was s(ω), where ω/2π is the frequency, the output of the integrator filter is simply sₒᵤₜ(ω)=1/(Δt·s(ω))

In the case of first order low pass filter, the frequency domain formula corresponds to sₒᵤₜ(ω)=1/(1+τ·s(ω)), where τ is the inverse of the cut-off frequency. An integrator has an infinite gain at zero frequency, while a low pass filter has a gain of 1 for frequencies much lower than the cut-off frequency.

FIG. 2a shows schematically the block diagram of a servo loop (30) and of a shock detection system (20), according to a first embodiment of the invention. The integral part (INT) of the feedback servo signal (FBSS) generated by the PID controller (44) may be tapped to an output (31) of the corresponding servo loop. The output (31) is connected to a signal input (21) of a shock detection system (20). The inputted signal (SIN) is sent to a signal comparator (22). The signal comparator (22) compares the inputted signal (SIN) with a threshold value and outputs to an output (29) a shock detection signal (SO). If the inputted signal (SIN) exceeds the threshold value, the signal comparator (22) outputs a high value for the shock detection signal (SO), corresponding to a detected mechanical shock.

In terms of a method for shock detection, the first embodiment corresponds to integrating the servo signal over a period of time and comparing the output of the integration step against a threshold value to decide if a mechanical shock affects the optical disc drive.

Two alternative embodiments for the first embodiment, not shown in the FIG. 2a are possible. In an alternative embodiment, the integration of the servo signal (SS) is performed by the digital signal processor DSP (110). The integrated signal is fed to the output (31), while the shock detection system (20) remains identical to the first embodiment.

In another alternative embodiment, the function of the whole shock detection system (20), comprising the signal comparator (22), is integrated in the digital signal processor DSP (110), so that the shock detection signal (SO) is directly generated by the digital signal processor DSP (110).

FIG. 2b shows schematically the block diagram of a servo loop (30) and of a shock detection system (20), according to a second embodiment of the invention. Herein the zero offset servo signal (ZOSS) is tapped and sent to the output (31) of the servo loop (30). This signal is fed to the input (28) of the shock detection system (20).

The shock detection system (20) comprises an input (28), an integrator (21), a signal comparator (22) and an output (29). The comparator generates to its output a shock detection signal (SO). A high value of the shock detection signal (SO) corresponds to a detected mechanical shock and it is generated if the input signal (SIN) exceeds a threshold value.

Optionally, the integrator (210 may also comprise a low pass filter (not shown in the figure), which may be implemented a simple RC filter, or alternatively the functions of the integrator and of the low pass filter (21) and of the signal comparator (22) may be performed by the digital signal processor (11) via a suitable firmware.

The cut off frequency of the low pass filter (21) is chosen below a characteristic mechanical resonance frequency of the optical disc drive. This allows the achievement of maximum signal to noise ratio for the shock detection signal (SO). In typical optical disc drives, this depends on their mass and the rigidity of the rubber suspensions, and it is in the order of magnitude of 100 Hz. Consequently the cut off frequency is preferably chosen below 15 Hz.

With respect to choosing a threshold value, setting a higher value of the threshold reduces the response time but, however, it increases the risk that errors may be made during the recording process. In the case of using the (FE) signal, the optimum signal to noise ratio could be obtained by the threshold value to 2% of the maximum focus error (FE) signal. Setting a low value of the threshold leads to false shock detection alarms due to signal noise. A value of the threshold of 2% of the maximum focus error (FE) signal provides an optimum between the signal to noise ratio and the response time of the sensor.

Most servo signals (SS) may take both positive and negative values. For example, in the case of focus error (FE) signal, a positive value may correspond to a disc too far and a negative value to a disc too close. Consequently, the input signal (SIN) received by the signal comparator (22) may be compared to two different threshold values to compensate for offsets, a first one for negative values of the input signal (SIN) and a second one for positive values. The shock detection system (20) may be implemented such that a mechanical shock is detected if input signal (SIN) received by the signal comparator (22) is negative and below a first threshold value or positive and above a second threshold value. The first and second threshold values may be chosen to be identical and consequently the absolute value of the received signal may be compared against a threshold value.

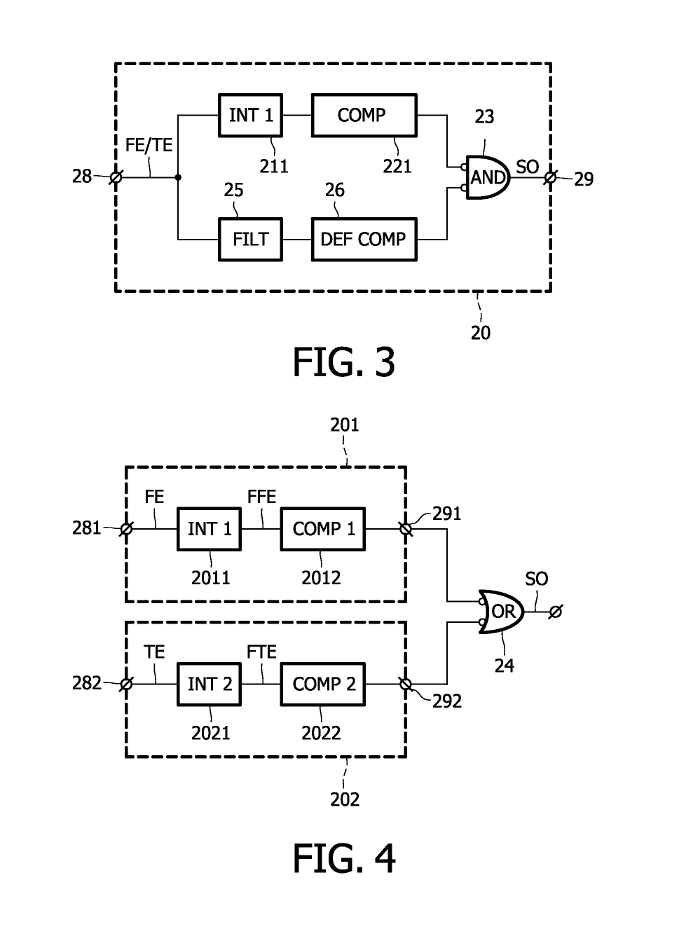

A third embodiment of the shock detection system (20) and of the corresponding optical disc drive will be discussed with reference to FIG. 3. Since disc defects like scratches, black dots or dust on the optical disc may also cause changes in servo signals (SS), false alarms due to disc defects may be generated. However, the changes in the focus (FE) or tracking (TE) error signals due to disc defects have different frequency components than the changes due to mechanical shocks. Usually mechanical shocks introduce much lower frequency components, also due to rubber damping present in the drive therefore the same focus (FE) or tracking (TE) error signals can be used to distinguish between disc defects and mechanical shocks. The desired servo signal (FE or TE) is fed to the signal input (28) of the shock detection system (20). The input signal (FE/TE) is fed simultaneously to two detection units. The first detection unit comprises an integrator (211) and a signal comparator (221), analogous to the second embodiment. If the input signal (FE/TE) exceeds a threshold value, the signal comparator (221) outputs a high signal corresponding to a detected shock. The second detection unit comprises a filtering unit (25) and a disc defect detection comparator (26). The disc defects detection comparator outputs a high signal if the input signal is below a disc defects detection value (meaning that no disc defects were detected). The output of the signal comparator (221) and of the scratch detection comparator (26) are fed to the inputs of an AND circuit (23). The AND circuit outputs a shock detection signal (SO) if simultaneously a mechanical shock was detected by the signal comparator (221) and no disc defects were detected by the disc defects detection comparator (26). In an alternative embodiment, the functions of the two filters, (211) and (25), of the two comparators, (221) and (26), and, of the logical AND circuit (22) may be performed by the digital signal processor DSP (110), for example by means of a suitable firmware.

In an alternative embodiment, the filtering unit (25) may comprise a high pass filter or a differential filter extracting a characteristic rise time of the signal.

A fourth embodiment of the shock detection system (20) and the corresponding optical disc drive will be discussed with reference to FIG. 4. As the best sensitivity for shocks perpendicular to the disc plane is provided by the focus error (FE) signal and by the tracking error (TE) signal for shock in the plane of the disc one may combine the two in advantage. The focus error (FE) signal and the tracking error (TE) signal are obtained simultaneously, each from its corresponding servo loop (30), and each fed to one of two inputs (281, 282) of the shock detection system (20). The focus error (FE) signal is passed through a first integrator (2011) and fed to a first signal comparator (2012). The first signal comparator (2012) generates a signal if the value of the filtered focus error (FFE) signal exceeds a first threshold value. The tracking error (TE) signal is passed through a second integrator (2021) and fed to a second signal comparator (2022). The second signal comparator (2022) generates a signal if the value of the filtered tracking error (FTE) signal exceeds a second threshold value. The output of the two signal comparators (2012,2022) is fed to the input of an OR circuit (24). The OR circuit (24) generated a shock detection signal (SO) if either signal comparator (2012 or 2022) generates a signal, corresponding to detecting a mechanical shock either in the radial or the axial direction with respect to the optical disc (1). In an alternative embodiment, the functions integrator (2011 and 2021), of the two signal comparators (2012 and 2022) and of the OR circuit (24) may be performed by the digital signal processor DSP (110), for example by means of a suitable firmware.

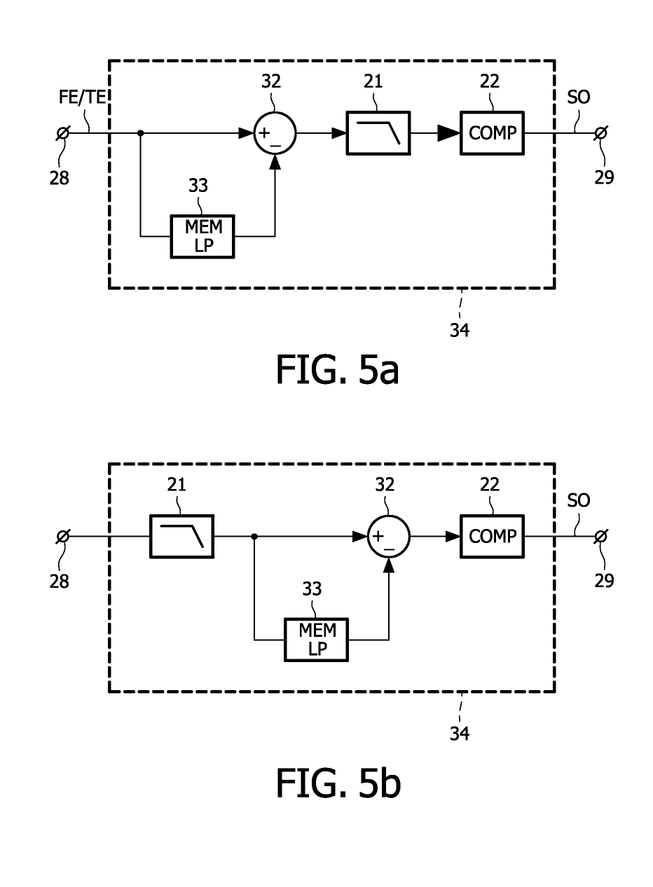

It is clear that in many systems a workable threshold with sufficient margin is difficult to find, as a desirable threshold may lie close or even below the noise level. A fifth embodiment of the shock detection system and the corresponding optical disc drive will be discussed with reference to FIGS. 5a and 5b. Herein a special characteristic of the noise is used: the noise is repetitive. The noise is coupled to the angle/rotation frequency of the disc and the noise changes slowly from track to track. This noise is referred to as disc noise. Apart from disc noise there are also repetitive disturbances caused by disc eccentricity and skew. The invention tackles also these disturbances.

In the embodiment of FIG. 5a, the desired servo signal (FE or TE) is fed to the signal input (28) of the shock detection system (20). Herein a copy of the desired servo signal (FE or TE) is passed through the memory loop filter. The output of the memory loop filter is subtracted from the original signal via a subtractor 32. The output of the subtractor is fed to the integrator 21 and the output of the integrator to the comparator 22. Optionally, the integrator may be replaced by a low pass filter. When the noisy servo error signals FE and TE are stored into a memory loop, they can be subtracted from the actual FE and TE signal. The outcome is a virtually noise free servo error signal. Or, to be more precise, noise components at the fundamental disc frequency and harmonics are considerably reduced.

FIG. 5b shows an alternative implementation to the one of FIG. 5a, wherein the integrator 21 is connected to the input before the memory loop filter. The implementation of FIG. 5b can be made more efficient with respect to memory usage, since the number of samples per revolution can be reduced. In an embodiment, the functions of the memory loop filter and the subtractor are integrated in the digital signal processor 110.

It should be noted that the embodiment as described with respect to FIGS. 5a and 5b can be combined with the defect detection as described with respect to FIG. 3 and with simultaneous detection of both FE and TE noise as described with respect to FIG. 5. Such combinations improve the overall shock detection efficiency.

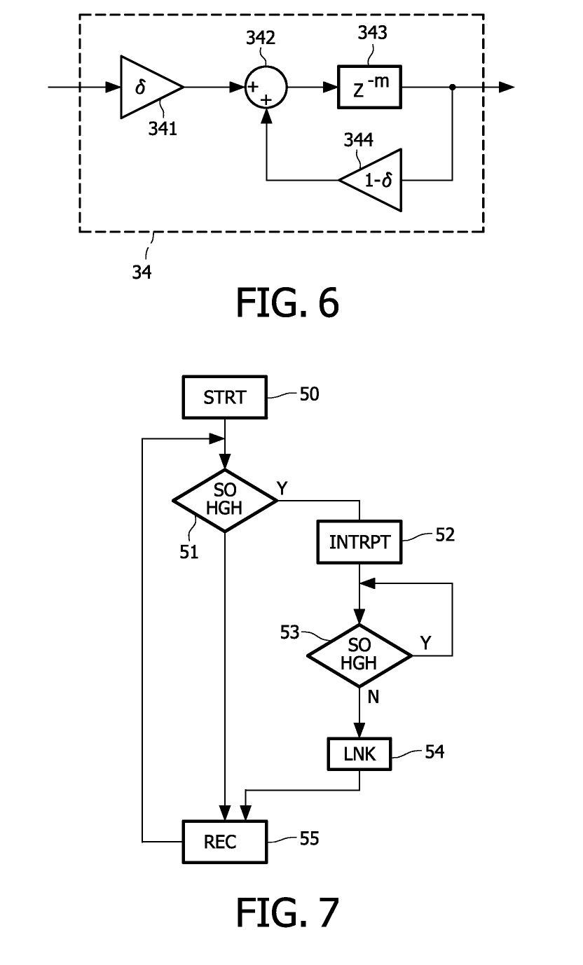

FIG. 6 shows schematically the block diagram of a memory loop filter. The delay element 343 is, for example, an n-taps shift register (FIFO). For each revolution of the disc n-samples are taken. The samples are distributed such that each sample corresponds to an angle of 2π/n radials on the disc. Elements 341 and 344 are amplifiers, having gains of δ and 1−δ, respectively, where the gain δ is a constant between 0 and 1 Element 342 is a signal adder.

The closed loop transfer function G(z) of such a memory filter is given by.

$$G ( z ) = δ \cdot \frac{1}{{z}^{n} - ( 1 - δ )}$$

For frequencies at the fundamental and harmonic modes of the rotational frequency of the disc zⁿ is equal to 1, so in this case the transfer function is:

$$G ( z ) = δ \cdot \frac{1}{1 - ( 1 - δ )} = 1$$

Other frequency components are attenuated. This filter is a comb filter. Although it is worth considering a simple memory loop filter without any feedback path in it, the use of a comb filter assures that only repetitive noise components are tackled. The use of a comb filter is more robust. On the other hand, a comb filter is a learning filter, so during the first revolutions of the disc, after the start of a recording, the threshold level must be higher since it takes some time until optimal noise reduction is achieved. However, when a drive is used, it always starts with reading data from disc, therefore this period can be used by the comb filter to start learning, so that the learning effect during write is shorter.

The number of taps (n) that is required depends on the needs of the application. Increasing the number of taps increases the maximum frequency component for which the noise that can be reduced. Normally it will be necessary to reduce also the frequency components that lie above the low pass filter cut-off frequency.

An embodiment of a recording method according to the invention will be discussed with reference to FIG. 7.

The method starts with a start step (50) when the shock detection mechanism is activated and the process of recording is started according to a known recording method suitable for the type of optical disc (1) inserted in the optical disc drive. The shock detection signal (SO) outputted by the shock detection system (20) is monitored continuously in step (51) (SO_HGH). As long as no mechanical shock is detected, the recording process continues uninterrupted in recording step (55). If a mechanical shock is detected by the shock detection system (20) and a shock detection signal (SO) is outputted, the recording process is interrupted in step (52). The interruption (52) of the recording process may be obtained, for example, by reducing the laser power from a write power level to a readout power lever. The exact laser beam position on disc when the recording process was interrupted is memorized. The shock detection signal (SO) is continuously monitored in step (53). When no more mechanical shock are detected (that is, when the shock detection signal (SO) is low), the recording process a linking method suitable for the type of optical disc inserted in the drive is used to resume recording. Preferably, the linking method allows the recording to be resumed from exact position when recording was interrupted. A linking method that allow to resume a recording from exact position when recording was interrupted down to bit level is know from our U.S. Pat. No. 6,697,209, to be inserted here by reference. After the linking process, the recording process continues in step (55)

An advantageous embodiment of the device according to the invention is obtained when the embodiments of FIGS. 3 and 4 are combined, that is each shock detection block (201 and 202) corresponding to FE error signal and TE error signal, respectively, are replaced by the embodiments of FIG. 3. This embodiment allows combining sensitivity to shocks in both axial and in-plane directions, while discriminating between disc defects and mechanical shocks. The preferred embodiment correspond to integrating all functional blocks of the said embodiment in the digital signal processor (110).

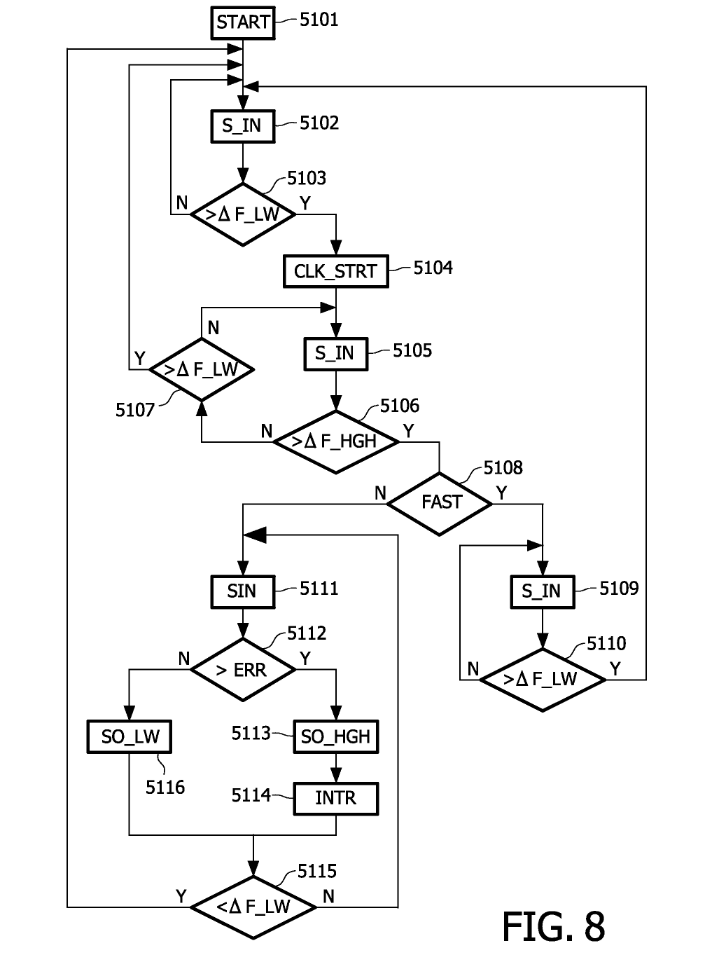

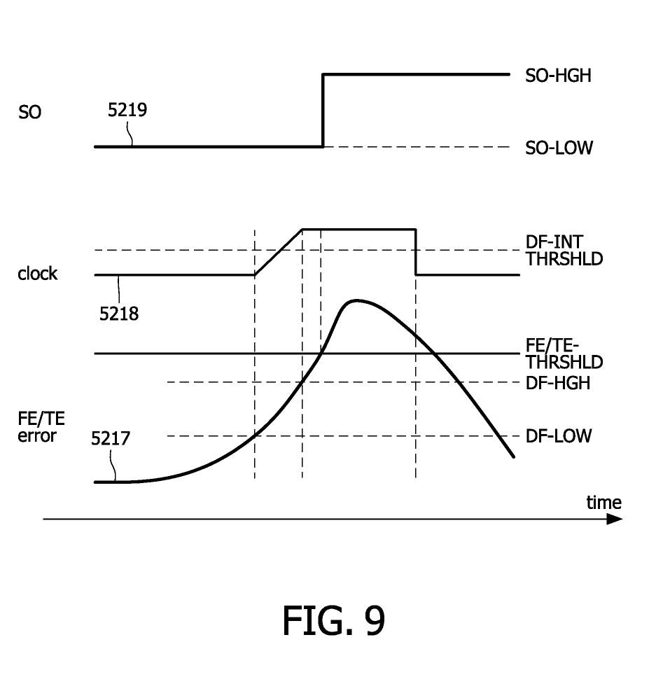

A preferred method of generating the shock detection signal will be discussed with reference to FIGS. 8 and 9.

The method of generating a shock signal starts in step (5101), when the process is activated. The value of integrated servo error signal (S_IN) is checked continuously in step (5102). If the value of the integrated servo error signal (S_IN) exceeds a low defect threshold (DF_LW), the defect monitoring is started by starting a clock counter in step (5104). The value of the integrated servo error signal (S_IN) is continuously checked in step (5104). If the said value drops below the low defect threshold (DF_LW), the clock counter is reset and the method return to step (5102). The said value is compared whether it exceeds a high defect threshold value (DF-HGH) in step (5106). If yes, the clock counter is stopped and compare against a threshold value (FAST) in step (5108). If the clock counter is below the (FAST) threshold value, the fast rise time corresponds to a defect and not a mechanical shock and the method proceeds to step (5109). Herein the value of integrated servo error signal (S_IN) is monitored continuously, followed by a comparison step (5110) against the low defect threshold (DF_LW). When the value of integrated servo error signal (S_IN) drops below the said threshold, the method return to step (5102). Returning to step (5108), if the clock counter is above the (FAST) threshold value, this corresponds to slow rise time due to a mechanical shock. Next, the value of integrated servo error signal (S_IN) is monitored continuously in step (5111) and compared against a shock threshold value (ERR) in step 5112. If the said value exceeds the shock threshold value, a mechanical shock is present and the shock signal (SO) is set to high (SO_HGH) in step (5113). Consequently, in step 5114 an interrupt signal may be sent to recording process. Returning to step (5112), if the value of integrated servo error signal (S_IN) does not exceed the shock threshold value (ERR), the shock signal is maintained low (SO-LW) in step 5116. Both steps (5116) and (5114) are followed by step (5115), in which the value of the integrated servo error signal (S_IN) is checked against the low defect threshold (DF_LW). If the said value drops below the threshold, the mechanical shock is passed and the shock signal is set to low (SO-LW) and the method returns to step (5102). If not, the method returns to step (5111).

In a preferred embodiment, the process of generating the shock signal is implemented in the Digital Signal Processor (110). The corresponding method will be discussed with reference to FIG. 9. The Digital Signal Processor (110) generates in real time the integrated servo error signal (5217) used in detecting the shock and maintains a clock counter (5218), a shock signal flag (5219), which may have two values, high (SO_HGH) and low (SO_LW), and a defect flag (not shown in the figure), which may have two values—defect detected (ON) and defect not detected (OFF). Initially the counter is set to zero, the defect flag is OFF and the shock signal is low (SO-LW). The value of integrated servo error signal (5217) is monitored continuously. When the said value exceeds a low defect threshold (DF_LW), the counter is started (moment t1 in FIG. 9). When the said value exceeds a high defect threshold value (DF_HGH) (moment t2 in FIG. 9), the counter is stopped and its value compared against a threshold value (DF_INT THRSHLD). If the said value is below the said threshold, the defect flag is set to ON. In the case shown in FIG. 9 the defect flag is maintained OFF. When the value of integrated servo error signal (5217) exceeds a shock detection threshold (FE/TE THRSHOLD) (moment t3 in FIG. 9) and if the defect flag is OFF, the shock signal flag (5219) is set to high (SO_HGH) and, consequently, the recording process may be interrupted. Whenever the value of integrated servo error signal (5217) drops below the defect low threshold (DF_LW), the counter and the flags are reset to the initial values.

It should be noted that the above-mentioned embodiments are meant to illustrate rather than limit the invention. And that those skilled in the art will be able to design many alternative embodiments without departing from the scope of the appended claims. In the claims, any reference signs placed between parentheses shall not be construed as limiting the claim. Use of the verbs “comprise” and “include” and their conjugations do not exclude the presence of elements or steps other than those stated in a claim. The article “a” or an” preceding an element does not exclude the presence of a plurality of such elements. The invention may be implemented by means of hardware comprising several distinct elements and by means of a suitable firmware. Firmware may be stored/distributed on a suitable medium, such as optical storage or supplied together with hardware parts, but may also be distributed in other forms, such as being distributed via the Internet or wired or wireless telecommunication systems. In a system/device/apparatus claim enumerating several means, several of these means may be embodied by one and the same item of hardware or software. The mere fact that certain measures are recited in mutually different dependent claims does not indicate that a combination of these measured cannot be used to advantage.

1. A method for detecting a mechanical shock affecting an optical disc drive during reading or recording information onto an optical disc, the optical disc drive comprising a lens system used in reading or recording information from the optical disc, servo means for controlling the positioning of the lens system relative to the optical disc, the servo means generating servo signals, the method comprising steps of
generating a first shock detection signal based on using at least one servo signal;
deciding that a mechanical shock is present if a value of the first shock detection signal exceeds a first threshold value;
the method characterized by
using a focus error signal (FE) and/or a tracking error (TE) signal from available servo signals for generating the first shock detection signal;
the first shock detection signal being proportional to a weighted time integration of the focus error signal (FE) and/or the tracking error (TE) signal.

2. A method according to claim 1, characterized by subtracting from the used servo signal a memory loop signal, the memory loop signal being proportional to a time delayed copy of the used servo signal.

3. A method according to claim 2, characterized by the subtraction being performed after the weighted time integration.

4. A method according to claim 2, characterized by memory loop signal corresponding to passing the used servo signal through a comb filter.

5. A method according to claim 1, characterized by using the focus error (FE) signal in generating the first hock detection signal.

6. A method according to claim 5, characterized by
generating a second shock detection signal, corresponding to integrating over time the tracking error (TE) signal;
deciding that a mechanical shock is present, if either a value of the second shock detection signal exceeds a second threshold value or a value of the first shock detection signal exceeds the first threshold value.

7. A method according to claim 1, characterized by low pass filtering the used servo signal in the generation step, the low pas filter having a cut-off frequency below a mechanical resonance frequency of the optical disc drive.

8. A method according to claim 1, characterized by
generating a scratch detection signal based on the at least one servo signal used for generating the first shock detection signal;
deciding that a mechanical shock is present if simultaneously a value of the first shock detection signal is above the first threshold value and a value of the scratch detection signal is below a scratch detection threshold value.

9. A method according to claim 8, characterized by using a characteristic rise time of the shock detection signal as the scratch detection signal.

10. A method according to claim 8, characterized by generating a scratch detection signal comprises
measuring a rise time corresponding to the time needed for the first shock detection signal to rise from a low defect threshold value to a high defect threshold value;
comparing the measured rise time against a scratch detection threshold value.

11. An apparatus for recording data onto an optical disc, comprising
a lens system for controlling an electromagnetic beam, used in reading or recording information from the optical disc;
servo means for controlling the positioning of the lens system relative to the optical disc, the servo means generating servo signals, the servo signals comprising at least a focus error (FE) signal and a tracking error (TE) signal;
signal generation means for generating a first shock detection signal based on using at least one servo signal;
comparison means for comparing the value of the first shock detection signal with a first threshold value;
decision means arranged such that a decision is made that a mechanical shock is present, if a value of the first shock detection signal is above the first threshold value;
characterized in that, the signal generation means are arranged such that the first shock detection signal is proportional to a time integral of the focus error (FE) signal and/or of the tracking error (TE) signal.

12. An apparatus according to claim 11, characterized in that further comprises
a memory loop filter; and
subtraction means for subtracting from the used servo signal a memory loop signal, the memory loop signal being generated by passing the used servo signal through the memory loop filter.

13. An apparatus according to claim 12, characterized in that the subtraction being performed after the weighted time integration.

14. An apparatus according to claim 11, characterized in that memory loop filter is a comb filter.

15. An apparatus according to claim 11, characterized in that the first shock detection signal is proportional to a time integral of the focus error (FE) signal.

16. An apparatus according to claim 12, characterized in that the apparatus further comprises
second signal generation means for generating a second shock detection signal proportional to time integral of the tracking error (TE) signal;
second decision means arranged such that a decision is made that a mechanical shock is present, if either a value of the second shock detection signal exceeds a second threshold value or a value of the first shock detection signal exceeds the first threshold value.

17. An apparatus according to claim 15, characterized in that, the signal generation means are arranged such that the shock detection signal is proportional to a low pass filtered focus error (FE) signal and/or of tracking error (TE) signal, wherein a cut-off frequency of the low pass filter is below a mechanical resonance frequency of the optical disc drive.

18. An apparatus according to claim 15, characterized in that it further comprises
means for generating a scratch detection signal based on the at least one servo signal used in generating the shock detection signal;
second decision means arranged such that a decision is made that a mechanical shock is present, if simultaneously a value of the first shock detection signal is above the first threshold value and a value of the scratch detection signal is below a scratch detection threshold value.

19. An apparatus according to claim 18, characterized in that, the scratch detection signal corresponds to a characteristic rise time of the first shock detection signal.

20. An apparatus according to claim 18, characterized in that, it further comprises means for:
measuring a rise time corresponding to the time needed for the first shock detection signal to rise from a low defect threshold value to a high defect threshold value.
comparing the measured rise time against a scratch detection threshold value.

21. An apparatus according to claim 15, characterized in that, the signal generation means comprise a digital signal processor arranged to integrate the used servo signal.

22. An apparatus according to claim 15, characterized in that, the shock detection signal is generated by a digital signal processor.

23. An apparatus according to claim 22, characterized in that, the digital signal processor is further arranged to comparing the first shock detection signal to the first threshold value.

24. An apparatus according to claim 22, characterized in that, the digital signal processor is further arranged to decide if a mechanical shock is present.

25. An apparatus according to claim 20, characterized in that the scratch detection signal is generated by a digital signal processor.

26. A recording method for recording data onto an optical disc in an optical disc drive, the method comprising
recording data onto the optical disc;
detecting if a mechanical shock affects the optical disc drive;
interrupting the recording if a mechanical shock is detected;
resuming the recording according to a suitable linking method when no shock is detected;
the recording method characterized by detecting if a mechanical shock affects the optical disc drive according to a method as claimed in claim 1.
